(19) United States
(12) Patent Application Publication
(10) Pub. No.: US 2007/0245048 A1
(43) Pub. Date: Oct. 18, 2007

(54) Transfer of Content Between Storage Devices

(75) Inventors: Ozcan Mesut, Eindhoven (NL); Jozef P. Van Gassel, Sevenum (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,990

(22) PCT Filed: Jun. 2, 2005
(86) PCT No.: PCT/IB05/51794

§ 371 Date: Dec. 4, 2006

(30) Foreign Application Priority Data
Jun. 3, 2004 (GB) 0412338.6

(51) Int. Cl. G06F 12/02

(52) U.S. Cl. 710/105

(57) ABSTRACT

Content is transferred between a first storage device (50) and a second storage device (20) when the devices are selectively connected. An order of priority is determined for content which requires transfer The content is then transferred according to the determined order of priority. This allows content to be transferred in an order which should ensure that the second storage device stores as much useful data as possible after interruption of the transfer The order of priority can be based on importance of the content (e.g. user defined importance settings, historical usage information, context information) or on size of the items. The order can also be based on the preferences of a user of one of the devices, which are either explicitly defined by the user or learned by the device. Individual items of content can be sub-divided and transferred in a different order, e.g. multi-layered audio or video.

This invention relates to a method of transferring content between storage devices and to control apparatus and software for performing the method.

There is considerable consumer interest in portable devices which can store and play media content such as audio tracks and video files. These devices allow the user to enjoy their favorite media content while they are away from their home or place of work. Portable devices include a rewriteable storage medium such as a solid state memory or hard drive such that a user can directly store media content of their choice on the device and change the content at a later date. More efficient media coding schemes and the decreasing cost of high capacity storage media have allowed portable devices of this kind to store a useful quantity of content.

It is desirable to connect a portable device to other storage devices in a home network so that a user can, for example, transfer audio or video files to the portable device before leaving the home network. The home network can comprise a single storage device, such as a personal computer, or a number of different devices. The connection between the portable device and home network can be a wired connection or, more typically, a wireless connection. It is desirable that the process of transferring content to/from the portable device is performed transparently to the user of the portable device. However, operating in this manner means transfer of content between the storage devices can be interrupted when a user decides to leave the home network.

The present invention seeks to provide an improved way of transferring content between storage devices.

Accordingly, a first aspect of the present invention provides a method of transferring content between a first storage device and a second storage device, the first storage being selectively connectable to the second storage device, the method comprising:

determining an order of priority for the content which requires transfer; and,

transferring the content according to the determined order of priority.

By determining an order of priority for the content, content is transferred in an order which should ensure that the second storage device stores as much useful data as possible after interruption of the transfer. Any content which is not transferred, due to interruption of the connection between the storage devices, can be transferred when the storage devices are reconnected. This allows the transfer of content between the storage devices to occur as a background process. The connection between the storage devices can be a wired connection, such as a cable, or a wireless connection which operates according to a wireless local area network standard or a personal area network standard.

The order of priority can be decided in a number of ways. The order of priority can be based on importance of the content files, or on size of the files. Importance can be based on historical usage information of one of the devices or the context in which the storage devices are being used, or about to be used. The order can also be based on the preferences of a user of one of the devices, which are either explicitly defined by the user or learned by a controller which implements the method. These can be user-specified indications of what the user considers to be most important to them, such as audio (in preference to video).

The method can be applied to a collection of content or to an individual item of content, where it is possible to sub-divide the item into multiple parts. Examples of this kind of content are: video, audio or images which comprise multiple layers of data representing layers of detail; video content with basic and predicted data; content with multiple audio or video formats; content which represents a folder of sub-items, such as the contents of a DVD. The content can be transferred in a way which will provide a minimum level of quality for the full duration of the content in the event that transfer is interrupted, by arranging that the entire base layer data (basic data or primary content) is transferred before any of the additional layer data (predicted data or supplementary content).

The storage devices can either be dedicated storage devices with or without the capability of rendering the stored content into a form for presentation to a user, such as an MP3 player or similar device, or they can be multi-functional devices with content storage and rendering capabilities, such as a personal computer, a personal digital assistant (PDA), mobile multimedia player or mobile telephone. Although the invention is particularly advantageous where one of the storage devices is a portable device, it can also be applied to a pair of fixed storage devices which are selectively connectable to one another, such as where one of the devices has been off-line for a period of time and there is a need to transfer content to or from the device which has been off-line.

The method can be used as part of a bidirectional transfer between the first and second storage devices. In an example situation where the first device is stationary and the second storage device is portable, it can be desirable to make a backup of the contents of the stationary device before downloading new content from the stationary device. The direction of transfer can be used as a factor in assigning an order of priority to content. As an example, a user (or the controller which implements the method) may decide that transfer from the portable device to the stationary device for the purposes of backup is assigned a higher order of priority than transfer of new material to the portable device.

In a networked situation where a third (or further plurality) of storage devices are involved in the transfer, the order of priority can either be established by coordination between the storage devices involved at the sending end of the transfer, or each of the storage devices can arrange a connection with the destination storage device and assign their own order of priority, with the transfer of content occurring in parallel across the connections.

The functionality described here can be implemented in software, hardware or a combination of these. The invention can be implemented by means of hardware comprising several distinct elements, and by means of a suitably programmed computer. Accordingly, another aspect of the invention provides software for performing the method. It will be appreciated that software may be installed on the storage device at any point during the life of the equipment. The software may be stored on an electronic memory device, hard disk, optical disk or other machine-readable storage medium. The software may be delivered as a computer program product on a machine-readable carrier or it may be downloaded directly to the storage device via a network connection.

A further aspect of the invention provides a control apparatus for a first storage device having a storage medium for storing media content and an interface for selectively communicating with a second storage device to transfer content between the devices, the control apparatus being operable to:

determine an order of priority for content which requires transfer; and,

transfer the content according to the determined order of priority. The control apparatus can also perform any combination of the steps of the method. A still further aspect of the invention comprises a storage device which incorporates the control apparatus.

Embodiments of the present invention will now be described, by way of example only, with reference to the accompanying drawings, in which:

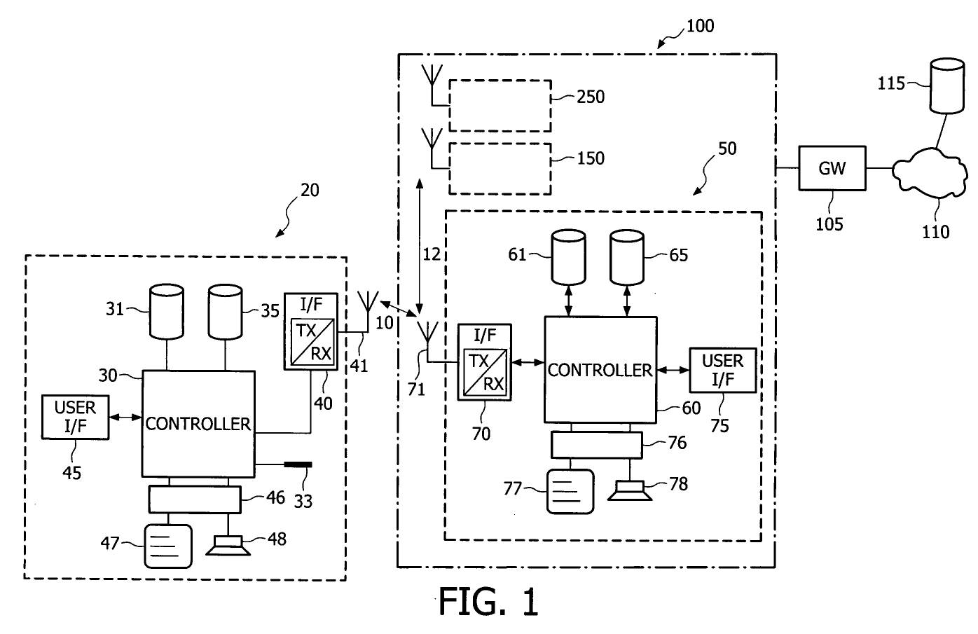

FIG. 1 shows a portable storage device and a home network of devices in a situation where transfer of content can occur;

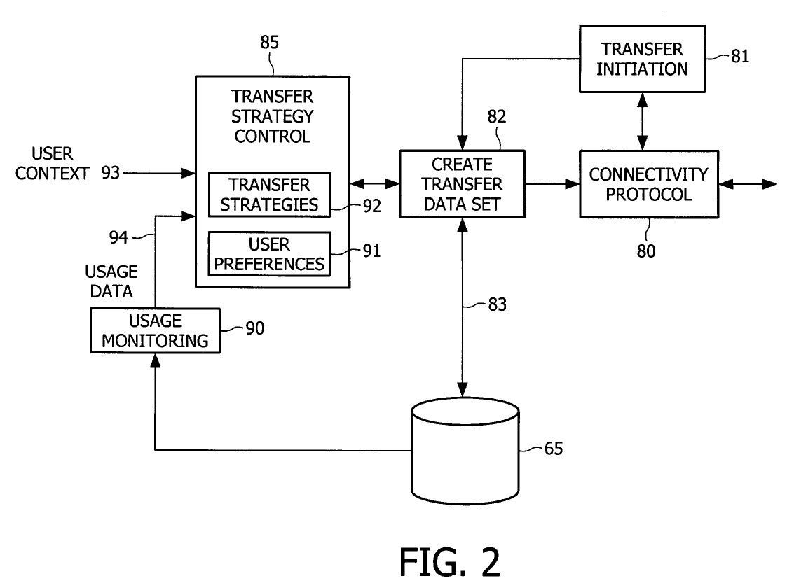

FIG. 2 shows functional blocks of a control system embodying the invention;

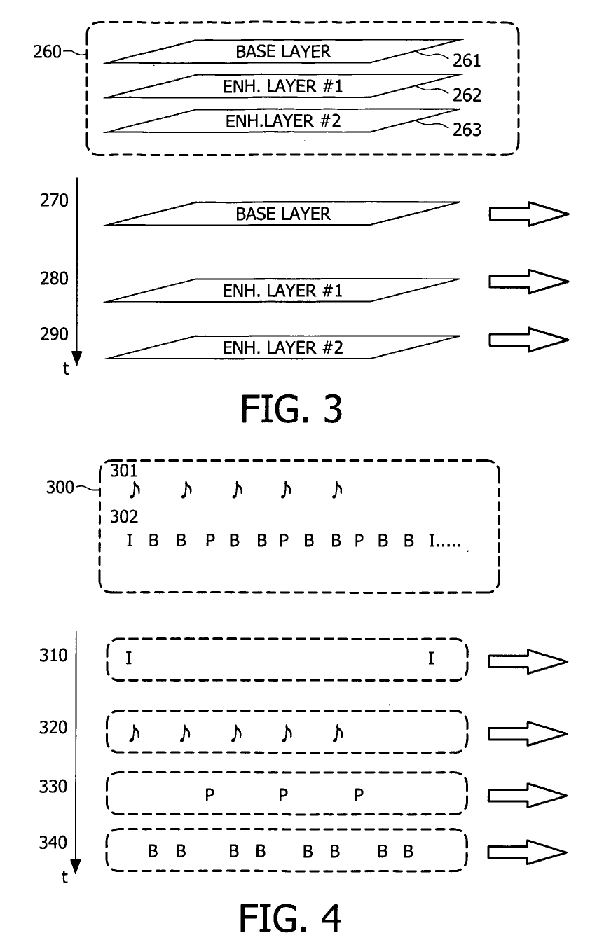

FIG. 3 shows a method of transferring layered video;

FIG. 4 shows a method of transferring coded video content;

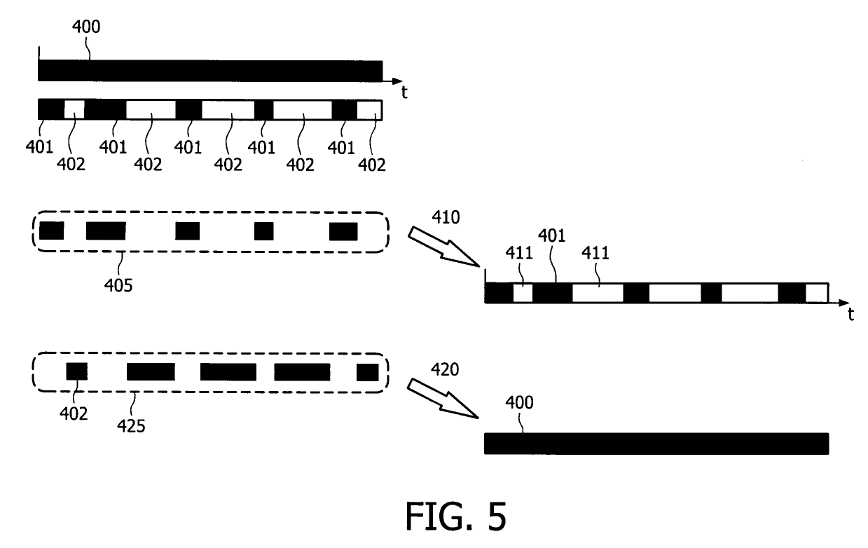

FIG. 5 shows a method of transferring content which is intended to be replayed in a linear manner.

FIG. 1 shows a network 100 of storage devices 50, 150, 250 which may exist, for example, in a user's home. One of the storage devices 50 is shown in detail. In this embodiment, storage device 50 is shown as a device which has both storage and rendering capabilities and it may represent, for example, a personal computer or a personal video recorder. Storage device 50 has a controller 60, such as a microprocessor, for controlling operation of the device. The microprocessor has a non-volatile memory device 61 connected to it for storing the operating software for the device and any user-defined preferences. The storage device 50 also comprises one or more stores 65 for storing media content. These stores can include: solid state memory devices such as flash memory; high capacity hard-drives; drives for playing optical disks, such as compact discs or Digital Versatile Discs (DVDS) or drives for reading/writing magneto-optical storage devices.

Storage device 50 also comprises apparatus 76 for rendering selected items of content for presentation to a user. This includes appropriate decoders for decoding the media content (such as an MP3 audio decoder and MPEG2 video decoder) and a digital to analogue converter. An audio output is amplified and fed to speaker 78 while a video output is fed to a display 77. It will be appreciated that the rendering unit 76 and/or the speaker 78 and display 77 can either be integrated with the storage device 50 (as shown) or separate from it. A user interface 75 allows a user to make selections and displays the current operating conditions and selections to the user. The user interface 75 can be a simple keypad or it can be a more complex device such as a touch-sensitive screen which may be combined with the display 77.

A wireless network interface 70, which includes an antenna 71, supports a communication link 12 between the storage device 50 and other devices 150, 250 in the home network 100. Network interface 70 also supports a communication link 10 with portable device 20. Although the connection between devices is shown as a wireless connection, it can alternatively be a wired connection. In the case of a wireless connection, network interface 70 supports a connection according to one of the IEEE 802.11 local area network (LAN) standards or a personal area network (PAN) standard such as Bluetooth™. A gateway 105 connects to an external network 110, such as the Internet, in which servers 115 provide content that may be transferred to the devices 50, 150, 250 or information which helps the device 50 in establishing an order of priority for transferring content.

Portable storage device 20 represents a device which can be freely moved into and out of the environment of the home network 100. It can be a small, hand-held, device or something larger. The portable device 20 comprises a controller 30 for controlling operation of the device in accordance with control software stored on a non-volatile memory 31. A store 35, such a solid-state memory, optical drive or hard disk drive, stores content. In this embodiment the portable device 20 also includes rendering capabilities which are similar to those of the storage device 50, such as audio and video decoders 46. User outputs include one or more audio speakers 48, a display 47 and line outputs (not shown) for connection to external equipment. A user interface 45 allows a user to interact with the device 20. Additionally, the portable device 20 can include an interface 33 for transferring data to/from other devices, such as a universal serial bus (USB) port. A communications interface 40 allows the portable device 20 to support a wireless communication link with network 100 when portable device 20 is within range of the network 100. Interface 40 comprises a transmitter/receiver 40 and antenna 41. If the portable device 20 requires a wired connection to other devices for the transfer of content, then the USB (or IEEE 1394 or similar) interface 33 may provide the main connection for the transfer of content.

As described above, portable device 20 and storage device 50 each include a communications interface 40, 70 which can support a communications link 10 between the devices when they are within range of one another. Standard protocols can be used to detect when devices 20, 50 are within range of one another. As an example, Universal Plug and Play (UPnP) includes a discovery process in which server devices automatically discover new devices by advertising their presence, obtaining an IP address and conveying their capabilities as well as learning about the presence and capabilities of other devices.

Once a communication link 10 has been established between portable device 20 and storage device 50 a content transfer process can begin. FIG. 2 shows the main functional units of the transfer management system. These functional units can be realised as blocks of code which are executed by controller 30 or 60. The main purpose of the transfer management system is to transfer items of content, or parts of a single item of content, in a prioritised way such that the receiving device ends up with as much useful data as possible after interruption of the transfer process. A connectivity protocol unit 80 supports a connection between units 20, 50 and manages transfer of selected data between the devices. A transfer initiation unit 81 detects when transfer should occur, and initiates the transfer process. Unit 81 may respond to a connection being established between units 20, 50 a user request for transfer to occur, or by detecting that the content held by devices 20, 50 is different. Unit 81 causes a ‘create transfer data set’ unit 82 to begin constructing a set of data that needs to be transferred between the devices 20, 50. This data set may comprise content which has recently been added to the storage device 50 from an external source (and hence data which has not yet been transferred to portable device 20) or data that a user has requested be transferred to the device 20, such as by a user interacting with user interface 75. A transfer strategy control unit 85 organises the data set created by unit 82 into a particular order of priority. It is this order of priority which is used to transfer the data set to the portable device 20. Strategy control unit 85 can operate in a number of different ways. Stored transfer strategies 92 and user preferences 91 can specify ways in which the unit 85 should operate under particular circumstances. Additionally, a particular transfer strategy can be selected based on the context in which the device or the user is in and stored usage data 94 which has been acquired 90 by logging usage of the system (by the user) over a period of time. Information 93 about the context (e.g. environment) in which the device is in is provided by an external unit (not shown) or by a user manually indicating where they intend to next use the device, such as a business trip, in the car, in the gym etc.

Unit 85 organises a set of data that is to be transferred in such a way as to optimise the data transport with respect to perceived quality (e.g. sending important data first) and robustness. This includes the processing of the actual data when necessary. Transfer of the organised data set is managed by connectivity unit 80, and during the transfer data 83 is delivered from store 65. If transfer is interrupted, transfer can be continued from the point at which it was interrupted, with the transfer management system storing details of the current status of the transfer.

Transfer management unit 85 can operate in one or more of the following ways:

Order According to Size

Order files according to their size, with small files having the highest priority (i.e. to be transferred first). This allows the greatest number of files to be transferred as possible in a given period of time, should transfer be interrupted.

Order According to Importance

Order files according to their importance, with most important files having the highest priority (i.e. to be transmitted first). This will ensure that the most important files will be transferred if transfer is interrupted. The importance of a file can be determined in a number of ways, such as by:
frequency of use. Frequency of use can be monitored 90 by the system and logged, with frequently used files being considered most important. When a user selects a number of files for transfer they are assigned a priority according to the monitored usage data 94;
a user-defined priority setting. The user sets their own list of priorities on a general basis (e.g. email=highest priority, documents=medium priority) or individually per file. In a similar manner to the previous method, the user can define a preferred set of file types (email, documents, music, video) or genres within a particular type (e.g. genres of music or movies);
a system-defined priority setting. This can be set in accordance with a list of file types and priorities. As an example, the order of priority can be as follows (highest listed first): database updates, new e-mail messages, documents, photos and video clips, audio and video. In an enhancement of this, the system learns of a user's preferences. When a user uses a particular file, the system notes the type of file. As an example, if a user listens to an audio track of a particular genre (e.g. rock) this is recorded by the system. If the user listens to lots of rock tracks, but not many easy listening tracks, the system deduces that the user prefers rock music. When a user selects a number of files for transfer, and these include audio tracks of the ‘rock’ genre, they will be given a higher priority than other audio tracks, even if the actual tracks selected for transfer have not been listened to by the user. Additionally, so-called community-based recommendations can be used. Information about the preferences of other people is acquired by unit 50 from an external source, such as server 115 connected to gateway 105. This information automatically suggests content that a user may also like based on other users liking the combination. Content that the user is likely to enjoy will be transferred first.
the context in which the device (or user) is in. The system may have a list of user-defined rules, or rules that it has learned itself based on a user's past behavior. As an example, a user may prefer to listen to a particular genre of music in the car (e.g. classical), a different genre of music while exercising (e.g. rock) and a different genre of music (or a different type of media content) while at home. Also, when the user is about to depart on a long journey, the user may wish to download some movies to pass time in a train or plane. A subsystem (not shown) acquires sensory data and other information to derive the context information 93 needed to realize this functionality. This information is supplied to the transfer control unit 85 when needed.

As described above, some types of content can be sub-divided into multiple parts and it is possible to reorder the parts of the item of content in a manner which will transfer a most useful part of the content first. As shown in FIG. 3, video content 260 is sometimes structured in multiple layers 261, 262, 263, with a base layer 261 representing a basic level of detail and one or more enhancement layers 262, 263 which each add a further, decreasing, level of detail. Steps 270-290 show the order in which unit 85 orders an item of video content for transfer. Firstly, at step 270, a base layer 260 (for the entire video clip or movie) will be transferred. Then, at step 280 the first of the enhancement layers 262 is transferred in full. Finally, the last (least detailed) enhancement layer is transferred in full. This allows the whole video clip to be viewed in at least a minimum level of quality in the event that transfer is interrupted. Still images and audio are further examples of content which can be processed in this manner.

While some content formats have explicit layers, in other formats the layering is more implicit. As an example, a multi-channel audio track (e.g. for a movie) comprises audio data for the left and right speaker signals as well as audio data for surround channels, such as the rear channels and low frequency channel. Data for one or more of the individual audio tracks can be transferred, in their entirety, before transferring data for the other channels.

A further technique can be applied in combination with the above, or instead of it. Certain types of video coding, e.g. MPEG-2 and MPEG-4, define different types of frames. As shown in FIG. 4, a sequence of frames in a video sequence 302 comprises I (intra) frames which are coded without reference to other frames; P (predicted) frames, which are coded from preceding I or P frames, and B (bidirectionally predicted) frames which are coded by bidirectional interpolation between the I or P frame which precedes or follows them.

Conventionally, data for an item of video content would be transferred in the sequence shown as 302. However, unit 85 modifies the normal sequence in which frames would be transferred into the sequence of steps shown as 310-340. This allows a temporal scalability/layering. It is assumed that the video clip 300 to be transferred comprises both images 302 and audio 301. Firstly, at step 310, only the I-frames are transferred. Audio may be transferred at the same time as the I frames, or as a subsequent step 320. If only this information is transferred to storage device 20 it will be possible to view the entire video clip at a very low refresh rate (typically 2 Hz), including audio. Next, the P frames are transferred at step 330. With the I-frames, audio and P-pictures the whole video can be viewed at a medium refresh rate (typically around 12 Hz). Finally, the B-frames are transferred at step 340 and the portable device now has the full video data. With all of the content transferred, the entire movie can be experienced at its original quality.

Some types of content, such as DVDs, comprise a collection of different parts. As an example, a DVD usually comprises video data for the main feature (film), video for special features and audio tracks in multiple languages and/or audio formats. Unit 85 can specify a particular order in which this type of content is transferred, such as: basic (stereo) audio and (base layer) video first, enhancement layer video, multi channel audio, special features (trailers, commentary, etc), subtitles, additional languages etc. These principles of reordering content can be applied to individual files within a set of data files which have already been prioritised for transfer (e.g. according to size or importance), or to content which has not been prioritised in any other way.

The categories above are not mutually exclusive. Unit 85 can use combinations of these to improve the quality (usefulness) of the information that is transferred between devices during a limited transfer period. As an example, it can be particularly beneficial to combine the techniques or ordering according to size and importance. Each file is assigned a weight which reflects a combination of the file's size and importance. Unit 85 can then order files according to the assigned weights.

One of the consequences of reordering the set of data (at stages 82, 85 FIG. 2) and then transferring data in the new order to a second storage device is that the second storage device may need to increase the amount of seeking during a playback process. This is not a problem where a collection of different items (files) are transferred, such as individual files relating to different audio clips. However, it does become a problem where the data represents an item of content that is intended to be replayed in a linear manner, such as a long video clip (movie). Re-ordering the sequence of the data, such as by re-ordering the sequence of I, B and P frames or layers in the ways just described can have a significant effect on the second storage device, as the playback will no longer be linear. A process for overcoming this problem is described with reference to FIG. 5. The data for an item of content 400, such as a video clip, is intended to be replayed in a linear manner as indicated by the time axis. As a result of a re-ordering process, some segments 401 of the data are assigned a high priority and are transferred as a group 405, at step 410, to a second storage device. The segments 401 may represent the Intra (I) frames of a MPEG coded video clip. At the second storage device the data transferred during step 410 is written to a storage medium. However, rather than writing the transferred data in a continuous block, the data is written in a manner which stuffs the gaps with so-called null-packets and empty frames 411 between the segments 401 in the file. The second storage device seeks forward between writing each segment 401 of data. In order to create a valid MPEG stream on the storage medium of the second device, special empty frames are inserted which cause a repetition of the previous frame on display (in combination with stuffing since empty frames are much smaller in size). The gaps 411 are sufficient to accommodate the segments 402 of the data 400 which have not yet been transferred. When transferred they will overwrite the null-packets (stuffing) and empty frames that were inserted. The sending device includes, as part of the transfer protocol, information about how much space needs to be left to accommodate the missing data.

Subsequently, remaining segments 402 are transferred as a group 425, at step 420, to the second storage device. Each of the segments 402 is written to one of the gaps 411 which had been left at the storage medium of the second storage device. Thus, the two sets of transferred data 401, 402 are interleaved into a single file which can be replayed in a linear manner. This has as an advantage that the necessary storage capacity is claimed at the time of writing the first set of data (step 410) and seeking during playback is minimised because playback will now be linear. The reduction in seeking also helps to reduce power consumption during playback.

It is preferred that the gaps 411 that are left during the first write operation should be filled with stuffing information (e.g. NULL-packets for MPEG transport streams). However, to allow the second storage device to make best use of the limited write time during transfer, it is preferable to write the stuffing information (null-packets and empty pictures) into the gaps at a later stage, just after transfer has been interrupted. While only two transfer steps 410, 420 are shown, it will be appreciated that the technique can be applied to a larger number of transfer steps, with sufficient space 411 being reserved during the write stage of the first transfer step to accommodate all of the data which may be transferred in subsequent transfer steps.

It has been described how a control entity (units 82, 85) on storage device 50 can determine an order of priority for transfer of content to portable device 20. The technique is equally applicable to transfer of content in the reverse direction, i.e. from portable storage device 20 to storage device 50. This situation can arise when the portable device 20 contains content which is not locally stored in network 100. In the case of transfer from portable device 20 to storage device 50, the decision of an order of priority can be made by the control entity in device 50, by a control entity in device 20 (which operates in the same manner as the control entity in device 50 previously described) or by negotiation between a control entity in device 20 and a control entity in device 50.

The main embodiments described above show transfer of data between a portable device and a fixed device. It will be appreciated that the invention can also be applied to two stationary devices which are not continuously connected together, such as a device which is off-line for a period of time or devices which do not normally form part of a network and which are occasionally connected together to transfer content between them.

In the networked situation shown in FIG. 1, two other storage devices 150, 250 are shown within network 100. It is possible that the content that is to be transferred is stored on several of the storage devices. In this case, an overall order of priority can be established based on coordination between the storage devices 50, 150, 250 involved in the transfer. As an example, a home network may include a personal computer 50 and a home AV server 150 and the portable storage device 20 and a user requests transfer of content from both the PC 50 and AV sever 150 to the portable storage device 20. The overall order of the files to be transferred to (or from) the portable mobile device 20 can be determined by coordination between the PC 50 and home AV server 150. In a further alternative, each of the stationary devices 50, 150, 250 arranges a connection with the portable device 20 and each assigns their own order of priority, with the transfer of content occurring in parallel across the connections.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim.

In the description above, and with reference to the Figures, there is described a method of transferring content between a first storage device (50) and a second storage device (20) when the devices are selectively connected. An order of priority is determined for content which requires transfer. The content is then transferred according to the determined order of priority. This allows content to be transferred in an order which should ensure that the second storage device stores as much useful data as possible after interruption of the transfer. The order of priority can be based on importance of the content files (e.g. user-defined importance settings, historical usage information, context information) or on size of the files. The order can also be based on the preferences of a user of one of the devices, which are either explicitly defined by the user or learned by the device. Individual items of content can be sub-divided and transferred in a different order, e.g. multi-layered audio or video.

1. A method of transferring content between a first storage device (50) and a second storage device (20), the first storage device (50) being selectively connectable (70, 40) to the second storage device (20), the method comprising:
determining an order of priority for the content which requires transfer; and,
transferring the content according to the determined order of priority.

2. A method according to claim 1 wherein the step of determining an order of priority comprises:
identifying the importance of content which is to be transferred; and,
assigning an order of priority which is related to importance, with most important content having the highest priority.

3. A method according to claim 2 wherein the step of identifying importance of content comprises monitoring usage (90) of content and recording, for each item of content, a value which is indicative of usage of that item.

4. A method according to claim 2 wherein the step of identifying importance of content comprises:
monitoring usage of types of content;
recording, for each type, a value indicative of usage.

5. A method according to claim 2 further comprising determining a context (93) in which at least one of the devices is being used, or will be used, and the step of identifying importance of content is based on the determined context.

6. A method according to claim 1 wherein the step of determining an order of priority comprises:
identifying sizes of items of content which are to be transferred; and,
assigning an order of priority which is related to size, with smallest items of content having the highest priority.

7. A method according to claim 1 wherein the step of determining an order of priority is based on the type of content that is to be transferred to the second storage device.

8. A method according to claim 1 wherein if the content comprises multiple layers of data (261, 262, 263), the step of determining an order of priority assigns an order which will transfer a first, base, layer (261) before transferring further, enhancement, layers (262, 263).

9. A method according to claim 8 wherein a first layer of data (261) is transferred for an entire item of content, before transferring any data for a further layer.

10. A method according to claim 1 wherein if the content comprises multiple audio formats, the step of determining an order of priority assigns an order which will transfer a basic audio format before transferring alternative audio formats.

11. A method according to claim 1 wherein if the content comprises video data having basic image data and predicted image data, the step of determining an order of priority assigns an order which will transfer all of the basic image data (310) before transferring any of the predicted image data (330, 340).

12. A method according to claim 11 wherein the basic image data comprises intra-frames (I-frames) and the predicted image data comprises predicted frames (P-frames) and bidirectionally predicted frames (B-frames).

13. A method according to claim 1 wherein the content comprises a data stream (400) which is intended to be read in a linear fashion, the method further comprising:
transferring (410) a first portion (405) of the content which has been assigned a first priority, the first portion comprising a set of segments (401) of the data stream which are spaced apart by segments (402) of data stream which are not transferred; and,
storing the first portion of the content on the second storage device in a manner which preserves the spacing of the segments of the data stream.

14. A method according to claim 13 further comprising:
transferring a further portion of the content which has been assigned a lower priority, the further portion comprising a further set of segments (425) of the data stream; and,
storing the further portion of content on the second storage device by inserting the further set of segments into the spaces that were reserved during the storage of the first portion of the content.

15. A method according to claim 13 wherein information about the required spacing is transferred with the first portion of the content.

16. A method according to claim 1 wherein the step of determining an order of priority is based on preferences of a user (91) of one of the devices which have been defined by the user.

17. A method according to claim 1 wherein the step of determining an order of priority is based on preferences of a user which have been learned by an apparatus which hosts the method.

18. Instructions for causing a processor to perform the method according to claim 1.

19. A computer program product comprising a machine-readable medium carrying instructions according to claim 18.

20. A control apparatus (60, 61) for a first storage device (50) having a storage medium (35) for storing media content and an interface (70) for selectively communicating with a second storage device (20) to transfer content between the devices, the control apparatus being operable to:
determine an order of priority for content which requires transfer; and,
transfer the content according to the determined order of priority.

21. A control apparatus according to claim 20, wherein determining an order of priority comprises:
identifying the importance of content which is to be transferred; and
assigning an order of priority which is related to importance, with most important content having the highest priority

22. A control apparatus according to claim 20 comprising a processor which is arranged to execute instructions.

23. A storage device comprising a storage medium (35) for storing media content, an interface (40) for selectively communicating with a second storage device to transfer content between the devices and a control apparatus according to claim 20.
